(19) United States
(12) Patent Application Publication
(10) Pub. No.: US 2011/0156880 A1
(43) Pub. Date: Jun. 30, 2011

(54) SYSTEM AND METHOD FOR CUSTOMIZING A COMPUTER SYSTEM

(76) Inventors: Paul T Rygaard, Los Gatos, CA (US); Robert Campbell, Cupertino, CA (US)

(21) Appl. No.: 13/062,693

(22) PCT Filed: Sep. 12, 2008
(86) PCT No.: PCT/US08/76219

§ 371 Date: Mar. 7, 2011

(51) Int. Cl. H04Q 5/22

(52) U.S. Cl. 340/10.1

(57) ABSTRACT

A system and method for customizing a computer system is disclosed herein. The computer system includes a controller and a storage device connected thereto. A software package having a plurality of modules is installed on the storage device. A reader is installed in the computer system. An identifier is placed on the computer system at least in dose proximity to the reader such that it is readable by the reader. The identifier corresponds to at least one of the plurality of modules such that, when the identifier is read by the reader at an initial boot up of the computer system, one or more modules automatically activates on the computer system and the computer system displays customized images.

### BACKGROUND

Computer manufacturers may install application programs onto their computer systems prior to shipping them. Some manufacturers provide application programs that are customized for a particular market, retailer or customer. Providing these customized computer systems may require that different programs be loaded onto each computer system that is to be shipped to a different market, retailer or customer, which is time-consuming and expensive. Customized computer systems are often manufactured in small batches rather than being mass-produced, which also increases the cost of the computer system and which complicates the overall supply chain and manufacturing processes.

### BRIEF DESCRIPTION OF THE DRAWINGS

FIG. 1 is a block diagram illustrating an embodiment of a system for customizing a computer system.

FIG. 2 is a block diagram illustrating an embodiment of the creation and customization of a computer system.

FIG. 3 is an isometric view illustrating an embodiment of a customized computer system.

FIG. 4 is a block diagram illustrating another embodiment of a system for customizing a computer system.

FIG. 5 is a block diagram illustrating another embodiment of the creation and customization of a computer system.

FIG. 6 is a flow chart illustrating a method for customizing a computer system.

### DETAILED DESCRIPTION

The system and method described herein enable a single software package to be loaded onto computer systems sent to different markets, retailers or customers. Using an identifier that is placed on the system after the initial manufacture thereof, the computer system may be customized based on information contained on the identifier.

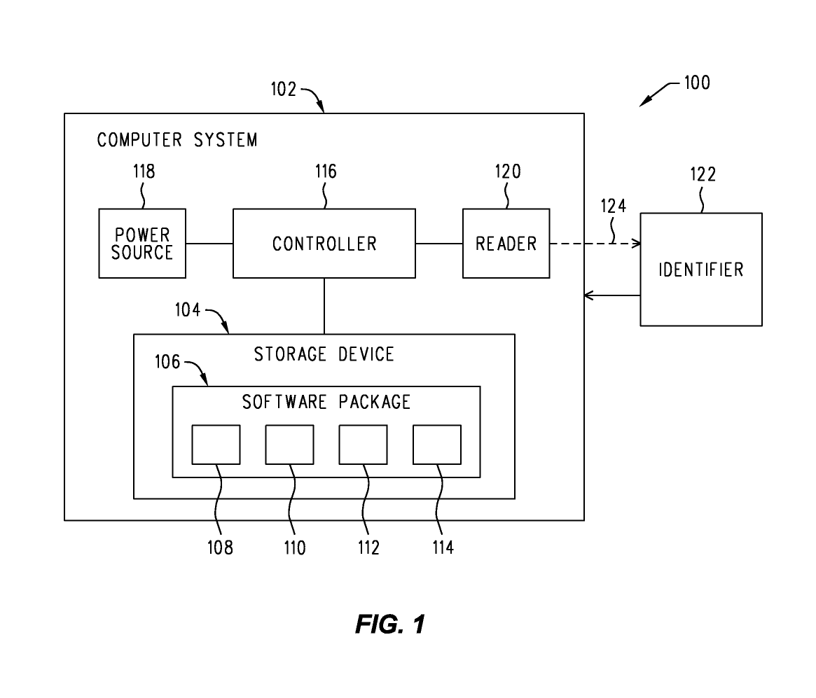

As shown in FIG. 1, the system 100 may comprise a computer system 102 having a storage device 104. System 100 can be any type of computing device, such as but not limited to, personal computers, servers, cell phones, personal digital assistant devices, notebooks, network attached storage devices, and the like. The storage device 104 can be any type of computer components, device and recording media that retains digital data, such as without limitation, non-volatile memory, optical disk, hard disks, and the like.

A software package 106 may be loaded onto the storage device 104 of the computer system 102. The software package 106 contains a plurality of modules 108, 110, 112, 114. Each of the modules 108, 110, 112, 114 contains programs, software images, and the like that are specifically adapted to a particular market, retailer or customer. While four modules 108, 110, 112, 114 are shown for illustrative purposes only, it is to be understood that any number of modules could be included in the software package 106. Also, as software programs are typically subject to continuous and ongoing upgrades, updates and revisions, the actual number of modules included in the software package 106 could vary at any given time.

The computer system 102 further comprises a controller 116 that is connected to the storage device 104. The controller 116 can be, without limitation, a microprocessor, specialized integrated circuit, or the like. A power source 118 is provided which is connected via the controller 116 to all of the components of the computer system 102 requiring power. A reader 120 is installed in the computer system 102. The reader can include an integrated circuit or software (not shown) that is capable of reading, scanning, decoding, deciphering, and/or receiving a particular input. The reader 120 is connected to, directly or indirectly, and controlled by the controller 116 and may share the controller=s connection to the power source 118. The preceding components as well as other computer components make up a Ageneric@ (i.e., non-customized) computer system 102 that can be mass-produced and then later be customized for a particular market, retailer or customer by simply placing an identifier 122 on the computer system 102 at least in close proximity to the reader (which is herein defined as being on the reader 120 or at a distance close enough for the reader 120 to read the identifier 122). The identifier 122, which will be described in further detail below, identifies which market, retailer or customer a system 100 is being shipped to. At the initial boot up of the computer system 102, after shipping the computer system 102 to its destination, the reader 120 reads the information on the identifier 122 preferably via a wireless (i.e., non-physical, wired) connection 124 and communicates that information to the controller 116. The controller 116 then communicates with the storage device 104 in order to automatically (i.e., without user intervention) activate one or more software modules 108, 110, 112, 114. One result of activating the module(s) is that images that are specific to a particular market, retailer or customer are displayed on the computer system 102 at the initial boot up thereof. It is to be understood that there may be other results when one or more software modules are activated on a computer system, some of which are specifically discussed with reference to the embodiments described below.

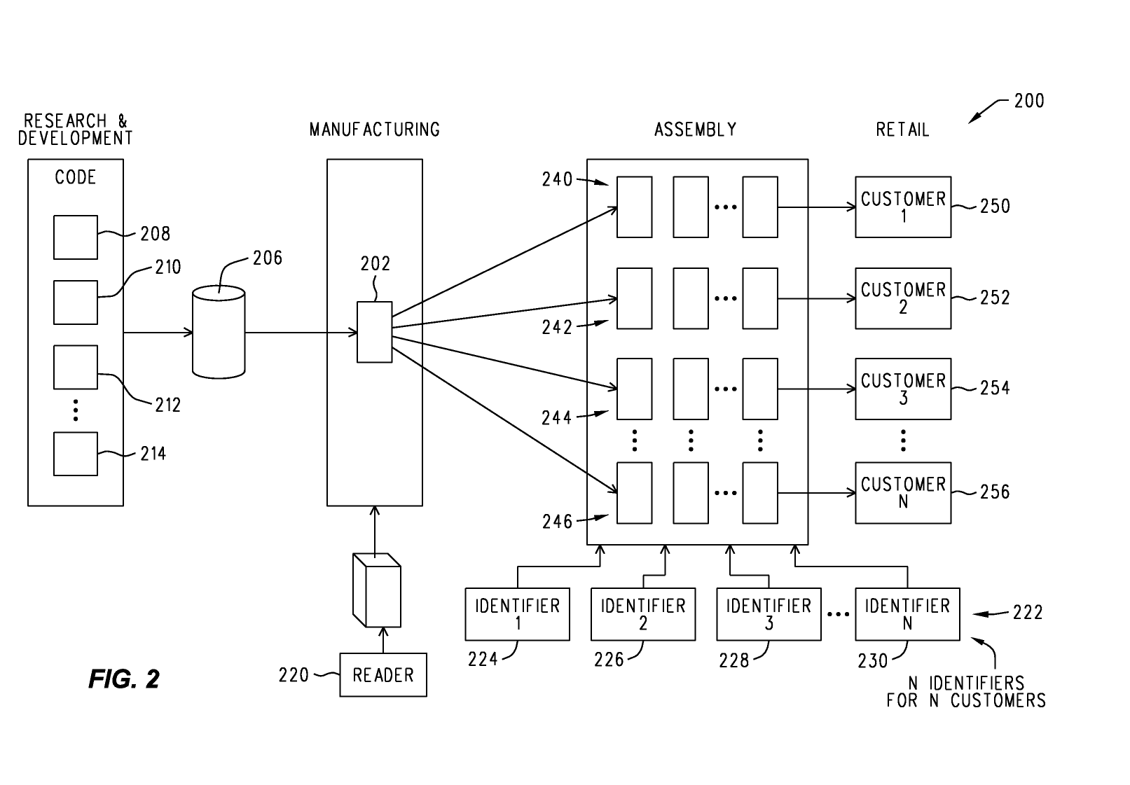

FIG. 2 is a block diagram 200 illustrating an embodiment of the creation and customization of a generic computer system 202. As described above and indicated in FIG. 2, the software package 206 may contain any number of a plurality of modules 208, 210, 212, 214. Each of the modules 208, 210, 212, 214 contains programs, software images, and the like that are specifically adapted to a particular market, retailer and/or customer. Also as described above, the generic computer system 202 includes a reader 220 that is controlled by a controller (116, FIG. 1).

In order to customize a system 202, an identifier 222 is placed thereon at least in close proximity to the reader 220. For example, to produce a first plurality of customized systems 240 that are specific to a first customer 250, a first identifier 224 is placed on a plurality of generic computer systems 202. At the initial boot up of the customized computer system 240, the reader 220 in the system 202 reads the identifier 224 preferably via a wireless (i.e., non-physical) connection (124, FIG. 1). Based on the information on the first identifier 224, one or more of the software modules (e.g., 208) is loaded into the appropriate memory device (e.g., RAM or the like, not shown) on the computer system 202. As a result of the software module(s) being activated on the system 202, images that are specific to the first customer 250 are displayed on the customized system 240 at the initial boot up thereof. The same process may also be completed using a second identifier 226 to create a second plurality of customized systems 242 for a second customer 252; a third identifier 228 to create a third plurality of customized systems 244 for a third customer 254; and an ANth@ identifier 230 to create a plurality of ANth@ customized systems 246 for an ANth@ customer 256. It is to be understood that a change in the information on an identifier 222 will create a different customized system (or a plurality of different customized systems) for a different customer.

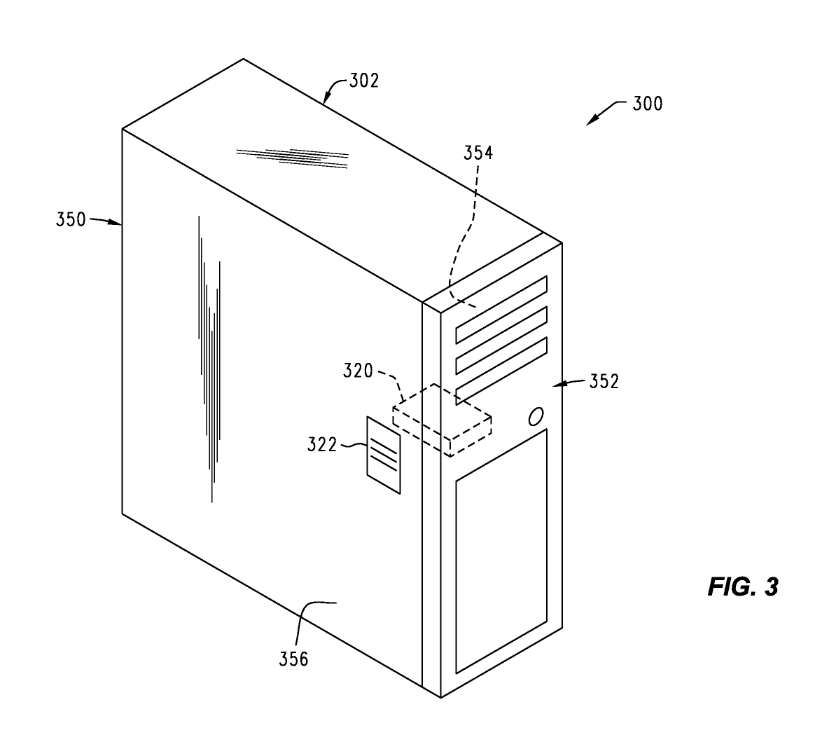

Another embodiment of a customized computer system 300 is illustrated in FIG. 3. In this embodiment, the reader (120, FIG. 1; 220, FIG. 2) may be, for example, a radio frequency identification (RFID) reader 320 of the type conventionally known in the art. The RFID reader 320 may be installed and positioned within the computer housing 350, for example, on the inside surface 354 of the front bezel 352 of the computer system 302 as indicated by dashed lines in FIG. 3. In this embodiment, the identifier (122, FIG. 1; 222, FIG. 2) would then be an RFID tag 322 which could be, for example, a sticker that is placed on an outside surface 356 of the computer housing 352 at least in close proximity to where the RFID reader 320 is installed. If the RFID tag 322 is placed in relatively close proximity to the RFID reader 320, then a low-power RFID reader could be utilized, which further reduces the cost of the system 300. Thus, the exact distance defined by close proximity@ would depend on the read range of the RFID reader installed in the computer system 302. For example, using an RFID reader with a read range of 0-5 inches, the Aclose proximity@ in which an identifier 322 such as an RFID tag would have to be placed to an RFID reader of that type would be between approximately 0 (i.e., directly on the reader 320) and 5 inches.

As a specific example of the embodiment shown in FIGS. 1-3, the generic computer system 102, 202 including a reader 120, 220 (which could be an RFID reader 320, FIG. 3) installed therein could be one of a plurality of mass-produced systems that will ultimately be shipped to several different retailers. A software package 106, 206 is loaded onto the storage device 104 of each computer system 102, 202. The software package 106, 206 contains a plurality of modules 108, 110, 112, 114, 208, 210, 212, 214, each of which corresponds to one or more retailers. For example, software modules 108, 208 could contain programs and images specific to a first retailer, including particular logos, trademarks and service marks used by the first retailer, as well as information specific to the first retailer such as the computer system=s stock-keeping unit (SKU) identifier. Similarly, software modules 110, 210 could contain programs and images specific to a second retailer, including their logos, trademarks, service marks, and SKU identifiers. Software modules 112, 212 could contain programs and images specific to a third retailer, including their logos, trademarks, service marks, and SKU identifiers. Software modules 114, 214 could contain programs and images specific to a fourth retailer, including their logos, trademarks, service marks, and SKU identifiers. Each computer system 102, 202 would be Acustomized@ by placing an identifier 122, 222 (such as, for example, an RFID tag 322, FIG. 3) on the computer system 102, 202 at least in close proximity to the reader 120, 220 (e.g., an RFID reader 320), thereby creating a customized computer system 240, 242, 244, 302. At the initial boot up of the customized system 240, 242, 244, 302, the reader 120, 220, 320 in the system reads the identifier 122, 222, 322. Based on the information on the identifier 122, 222, 322, one or more of the software modules 108, 110, 112, 114, 208, 210, 212, 214 corresponding to the retailer identified on the identifier 122, 222, 322 is loaded into the appropriate memory device (e.g., RAM or the like, not shown) on the computer system 240, 242, 244, 302. As a result, images that are specific to that particular retailer are displayed on the computer system 240, 242, 244, 302 at the initial boot up thereof.

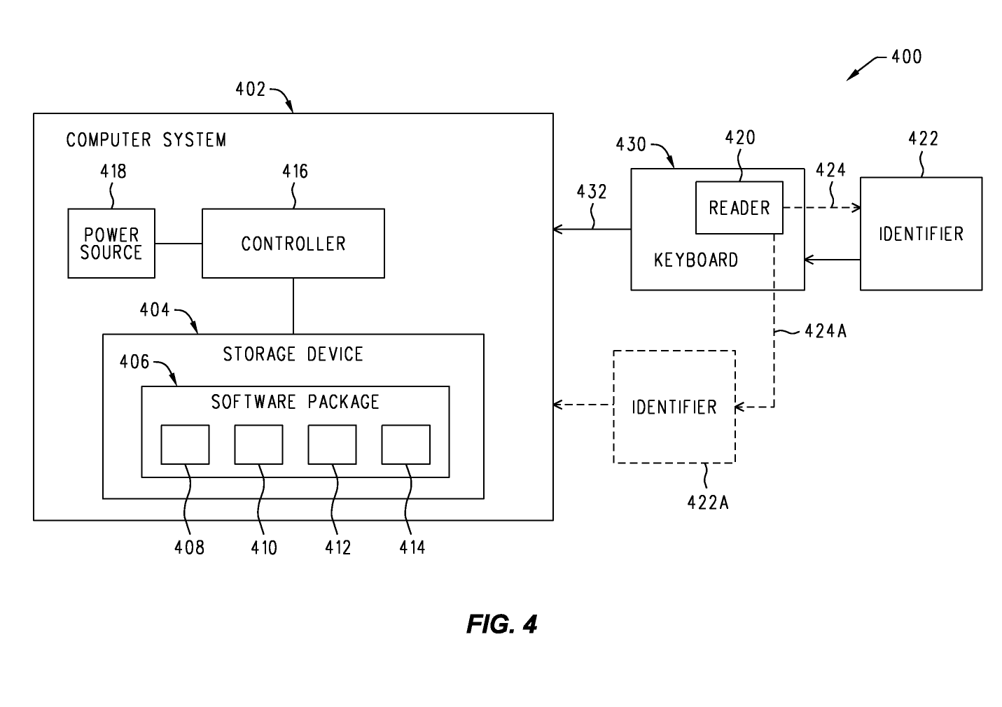

In another embodiment shown in FIG. 4, the customized computer system 400 may comprise a computer system 402 having a storage device 404. A software package 406 is loaded onto the storage device 404 of the computer system 402. The software package 406 contains a plurality of modules 408, 410, 412, 414 (four modules are shown for illustrative purposes only). Each of the modules 408, 410, 412, 414 contains programs, software images, and the like that are specifically adapted to a particular market, retailer or customer. The computer system 402 further comprises a controller 416 such as a conventional motherboard that is connected to the storage device 404. A power source 418 is provided which is connected via the controller 416 to all of the components of the computer system 402 requiring power. The system 400 further comprises a keyboard 430. A reader 420 is installed in the keyboard 430 and shares the keyboard=s connection 432 (whether wired or wireless) to the computer system 402. The reader 420 is therefore connected to the controller 416 and the power source 418 via the keyboard connection 432. The preceding components as well as other standard computer components make up a Ageneric@ (i.e., non-customized) computer system 402 that can be mass-produced and then later be customized for a particular market, retailer or customer by simply placing an identifier 422 such as that described herein on the computer system 402 at least in close proximity to the reader 420, most preferably directly on the keyboard 430 in this embodiment. At the initial boot up of the system 400, the reader 420 reads the information on the identifier 422 preferably via a wireless (i.e., non-physical) connection 424 and communicates that information to the controller 416. As indicated in dashed lines in FIG. 4, an identifier 422A could alternatively be placed directly on the computer system 402 in close enough proximity to the reader 420 in the keyboard for the reader 420 to read the identifier 422A preferably via a wireless (i.e., non-physical) connection 424A. The controller 416 then communicates with the storage device 404 in order to automatically (i.e., without user intervention) activate a particular software module 408, 410, 412, 414. As a result, images that are specific to a particular market, retailer or customer are displayed on the computer system 402 at the initial boot up thereof.

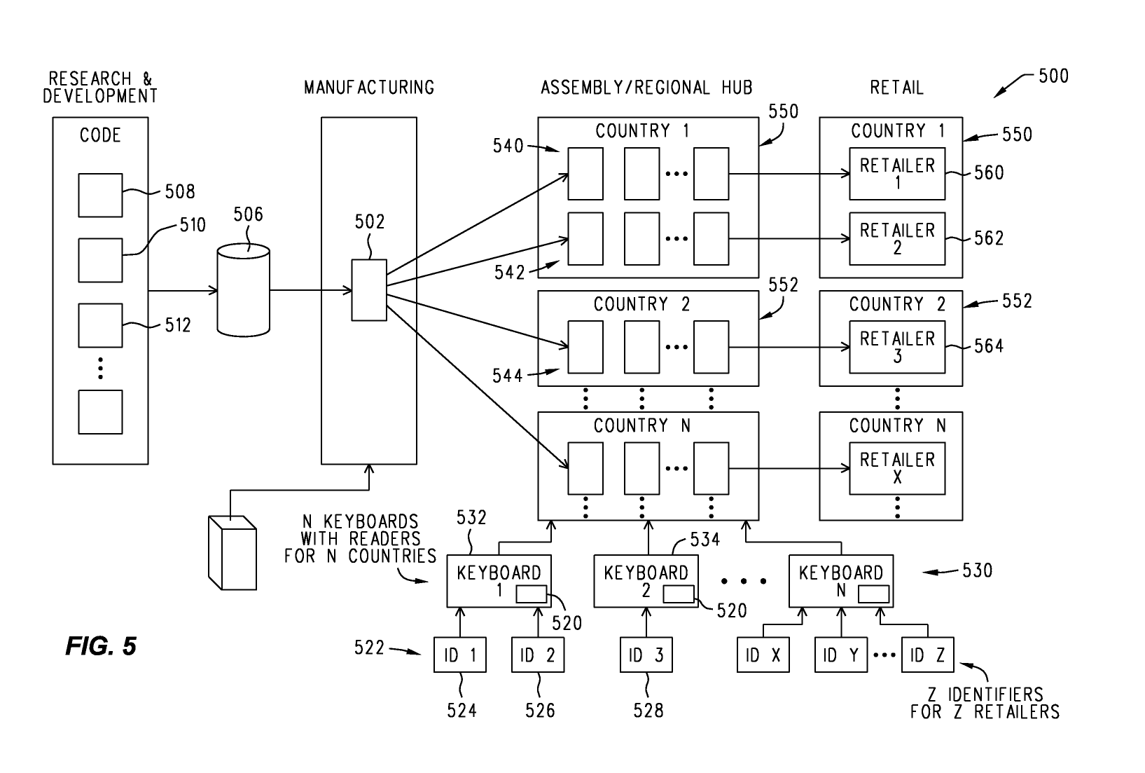

Yet another embodiment of a system 500 is illustrated in FIG. 5. In this embodiment, the generic computer system 502 could be one of a plurality of mass-produced systems that will be customized for different retailers in different particular countries. A keyboard 530 having a reader 520 such as, for example, an RFID reader will be included with each of the systems 502. Each keyboard 530 is associated with a particular country, e.g., keyboard 532 may be associated with France and keyboard 534 may be associated with Germany. The French keyboard 532 would include letters and symbols specific to the French language and culture, and the German keyboard 534 would include letters and symbols specific to the German language and culture. A software package 506 is loaded onto the storage device (e.g., 404, FIG. 4) of each computer system 502. The software package 506 contains a plurality of modules (e.g., 508, 510, 512), each of which corresponds to a particular retailer within a particular country. For example, software module 508 could contain programs and images in the French language, a driver for a French keyboard 532, and programs and images specific to a first retailer in France, including their logos, trademarks, service marks, and SKU identifiers. Software module 510 could also contain programs and images in the French language as well as a driver for a French keyboard 532, and programs and images specific to a second retailer in France. Software module 512 could contain programs and images in the German language as well as a driver for a German keyboard 534, and programs and images specific to a third retailer in Germany (who may or may not be the same as the first or second retailer in France). An identifier 522 such as, for example, an RFID tag is placed on each computer system 502 at least in close proximity to the reader 520 (preferably, in this embodiment, directly on the keyboard 530) that identifies the destination (including country and retailer) for that particular system 502. For example, as shown in FIG. 5, a first identifier 524 could be placed on a French keyboard 532, and a second identifier 526 could be placed on another French keyboard 532. A third identifier 528 could be placed on a German keyboard 534. It is to be understood that, while two keyboards and three identifiers are specifically described above, any number AN@ of keyboards corresponding to the number of destination countries, as well as any number AZ@ of identifiers corresponding to the total number of retailers in all of the countries, can be utilized in the system 500.

In this manner, a plurality of customized systems 540, 542, 544 are created. These systems 540, 542, 544, each including a country-specific keyboard 532, 534, could all be shipped to regional hubs 550, 552 in their destination country. From there, each customized computer system 540, 542, 544 may be shipped to a particular retailer 560, 562, 564 in its destination country. For example, each of the customized computer systems 540, 542 with French keyboards 532 could be shipped to a regional hub 550 in France. From there, the first plurality of customized systems 540 could be shipped to the first retailer 560 in France, and the second plurality of customized systems 542 could be shipped to the second retailer 562 in France. The third plurality of customized computer systems 544 with German keyboards 534 could be shipped to a regional hub 552 in Germany and then to the third retailer 564 in Germany (which may or may not be the same as the first or second retailer 560, 562 in France).

At the initial boot up of a computer system 540, 542, 544, after the keyboard 532, 534 has been connected thereto, the identifier 524, 526, 528 is read by the reader 520, which communicates the information on the identifier to the controller (e.g., 416, FIG. 4). The controller then communicates with the storage device (e.g., 404, FIG. 4) in order to automatically (i.e., without user intervention) activate the software module 508, 510, or 512 corresponding to the particular retailer and country identified on the identifier 524, 526, 528. As a result, at the initial boot up thereof, each of the computer systems 540 shipped to the first retailer 550 in France (the first country 560) will display images thereon that are specific to the first retailer 550 in France, and the system will be set up to accept the French keyboard 532. Similarly, at the initial boot up thereof, each of the computer systems 542 shipped to the second retailer 552 in France (the first country 560) will display images thereon that are specific to the second retailer 552 in France, and the system will be set up to accept the French keyboard 532. In addition, at the initial boot up thereof, each of the computer systems 544 shipped to the third retailer 554 in Germany (the second country 562) will display images thereon that are specific to that retailer 554 in Germany, and the system will be set up to accept the German keyboard 534.

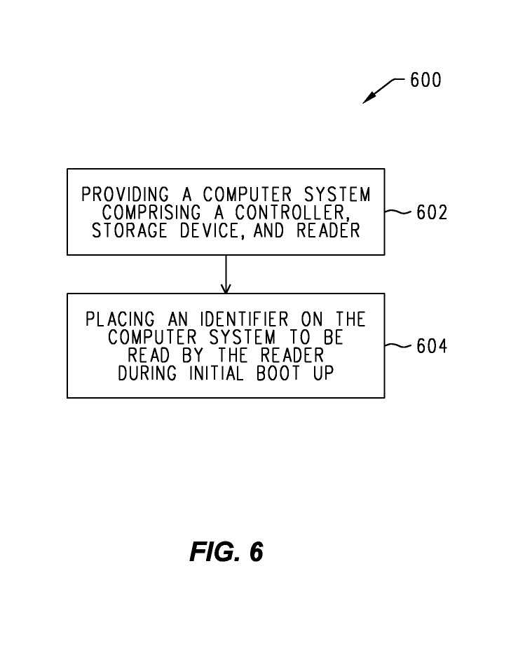

With reference to FIGS. 1-5, FIG. 6 illustrates a method 600 for customizing a computer system. The method 600 comprises an initial step 602 of providing a computer system 102, 202, 302, 402, 502 such as that described above. The computer system 102, etc. comprises a controller 116, 416 and a storage device 104, 404 connected to the controller 116, 416. The storage device 104, 404 has software package 106, 206, 406, 506 installed thereon that has a plurality of modules 108, 110, 112, 114, FIG. 1; 208, 210, 212, 214, FIG. 2; 408, 410, 412, 414, FIG. 4; 508, 510, 512, FIG. 5. A reader 120, 220, 320, 420, 520 is installed in the computer system 102, etc., and is connected to the controller 116, 416 and the storage device 104, 404. The next step 604 involves placing an identifier 122, 222, 322, 422, 422A, 522 on the computer system 102, etc. at least in close proximity to the reader 120, etc. such that the identifier 122, etc. is readable by the reader 120, etc. in the computer system 102, etc. The identifier 122, etc. corresponds to at least one of the plurality of modules 108, etc. such that, when the identifier 122, etc. is read by the reader 120, etc. at an initial boot up of the computer system 102, etc., the module automatically (i.e., without user intervention) activates on the computer system 102, etc. such that the computer system dispays customized images.

The foregoing description has been presented for purposes of illustration and description. It is not intended to be exhaustive or to limit the invention to the precise form disclosed, and other modifications and variations may be possibe in light of the above teachings. The exempary embodiments were chosen and described in order to best explain the applicable principles and their practical application to thereby enable others skilled in the art to best utilize various embodiments and various modifications as are suited to the particuar use contemplated. It is intended that the appended claims be construed to incude other afternative embodiments except insofar as limited by the prior art.

We claim:

1. A system for customizing a computer system, comprising:
a controller;
a storage device connected to the controller and having a software package installed thereon, the software package comprising a plurality of modules;
a reader installed in the computer system, the reader being connected to the controller and the storage device;
an identifier placed on the computer system at least in close proximity to the reader such that the identifier is readable by the reader, the identifier corresponding to at least one of the modules such that, when the identifier is read by the reader at an initial boot up of the computer system, the at least one of the modules is automatically activated on the computer system and customized images are displayed on the computer system.

2. The system of claim 1 wherein the reader is an RFID reader and the identifier is an RFID tag.

3. The system of claim 1, the computer system further comprising a housing having an inside surface and an outside surface, wherein the reader is mounted on the inside surface of the housing, and the identifier is placed on the outside surface of the housing.

4. The system of claim 1, wherein the identifier identifies a retailer to which the computer system is going to be shipped, and the customized images are specific to the retailer.

5. The system of claim 1, the computer system further comprising a keyboard, wherein the reader is installed in the keyboard of the computer system.

6. The system of claim 5 wherein the identifier is placed on the keyboard.

7. The system of claim 5, the computer system further comprising a housing having an inside surface and an outside surface, wherein the identifier is placed on the outside surface of the housing.

8. The system of claim 4, wherein the keyboard corresponds to a country to which the computer system is going to be shipped, the identifier identifies the country and a retailer to which the computer system is going to be shipped, and the customized images are specific to the country and the retailer.

9. A computer system, comprising:
a reader installed in the computer system;
an identifier positioned on the computer system at least in close proximity to the reader;
a software package having a plurality of modules, wherein the identifier corresponds to at least one of the plurality of modules; and
a computer-readable medium having a set of instructions thereon that causes the reader to read the identifier at an initial boot up of the computer system and automatically activate on the computer system the at least one of the modules corresponding to the identifier such that the computer system displays customized images.

10. A method for customizing a computer system, comprising:
providing a controller, a storage device connected to the controller, and a reader installed in the computer system, the reader being connected to the controller and the storage device, wherein a software package comprising a plurality of modules is installed on the storage device;
placing an identifier on the computer system at least in close proximity to the reader such that the identifier is readable by the reader, the identifier corresponding to at least one of the plurality of modules such that, when the identifier is read by the reader at an initial boot up of the computer system, the at least one of the modules is automatically activated on the computer system and the computer system displays customized images.

11. The method of claim 10 wherein the reader is an RFID reader, and the identifier is an RFID tag.

12. The method of claim 10, the computer system further comprising a housing having an inside surface and an outside surface, wherein the reader is mounted on the inside surface of the housing, and the identifier is placed on the outside surface of the housing.

13. The method of claim 10, wherein the identifier identifies a retailer to which the computer system is going to be shipped, and the customized images are specific to the retailer.

14. The method of claim 10, the computer system further comprising a keyboard, wherein the reader is installed in the keyboard of the computer system.

15. The method of claim 10 wherein the identifier is placed on the keyboard.

16. The method of claim 14, the computer system further comprising a housing having an inside surface and an outside surface, wherein the identifier is placed on the outside surface of the housing.

17. The method of claim 14, wherein the keyboard corresponds to a country to which the computer system is going to be shipped, the identifier identifies the country and a retailer to which the computer system is going to be shipped, and the customized images are specific to the country and the retailer.
